(19) United States
(12) Patent Application Publication
(10) Pub. No.: US 2018/0069201 A1
(43) Pub. Date: Mar. 8, 2018

(54) BATTERY

(71) Applicant: Dean Shane MARCUS, Germiston (ZA)

(72) Inventor: Dean Shane MARCUS, Germiston (ZA)

(21) Appl. No.: 15/559,998

(22) PCT Filed: Mar. 16, 2016
(86) PCT No.: PCT/ZA2016/050011

§ 371 Date: Sep. 20, 2017

(30) Foreign Application Priority Data
Mar. 20, 2015 (ZA) 2015/01919
Apr. 9, 2015 (ZA) 2015/02359

(51) Int. Cl. H01M 2/02; H01M 2/10; H02J 7/00; H01M 10/42

(52) U.S. Cl. CPC H01M 2/024; H01M 2/0245; H01M 2/1077; H01M 10/12; H01M 10/42; H02J 7/0031; H02J 7/0042

(57) ABSTRACT

A battery which includes a case and an electrical energy storage arrangement inside the case, wherein the case includes at least one fastener formation for a fastener which is used to secure the case to an anchor point thereby to restrict unwanted movement of the case.

### BACKGROUND OF THE INVENTION

This invention relates generally to a battery and more particularly to a battery which includes a security arrangement which helps to prevent unauthorised detachment of the battery from an installed location.

The invention is described hereinafter with reference to a telecommunication environment but this is exemplary only and non-limiting.

A cellular telephone network includes a large number of cells each of which is powered by a suitable energy source. Particularly for backup purposes, in the event of a mains power supply failure, batteries are essential for continued operation of each cell.

Valve-regulated lead acid batteries are in widespread use. Typically each battery includes a case which is manufactured from a suitable plastics material such as ABS or PPO (polyphenylene oxide) in which an electrical energy storage arrangement which includes a plurality of lead plates, is kept. Each battery provides a specified voltage e.g. 12 volts and, normally, four batteries are connected to one another in series using suitable links to provide an assembly with an operating voltage of 48 volts. The batteries are made in standard sizes so that irrespective of the source of supply the batteries can be mounted inside industry standard cabinets or racks e.g. with dimensions of 23″ or 19″.

Each battery weighs of the order of 60 kg and when the batteries are interconnected by the links, the assembly has a mass of the order of 240 kg It is not really possible for the four interconnected batteries to be removed from an installation location in unison. Typically a thief who wants to steal a battery would cut the links so that each battery, weighing about 60 kg, could be removed from the installation location.

These batteries are prone to theft. Each battery case however is relatively smooth and has no protrusions or hard points other than two electrical terminals on a top of the case.

Practically no excess space is available in a standard 23″ cabinet or rack which can be utilised to secure a battery in position and so render it less liable to be stolen.

The possibility of re-engineering a battery case is limited in that given the large number of existing installations it is desirable to be able to replace a battery which has a conventional case, with a battery which has a re-engineered case, without making substantial modifications to the housing or rack, in which the batteries are installed, to take account of the re-engineering process.

An object of the present invention is to provide a battery which to a substantial extent addresses the aforementioned factors.

### SUMMARY OF THE INVENTION

The invention provides a battery which includes a case and an electrical energy storage arrangement inside the case, wherein the case includes at least one fastener formation for a fastener which is used to secure the case to an anchor point thereby to restrict unwanted movement of the case.

Preferably the fastener formation is not normally visible nor easily accessible. The fastener formation may for example be located in a hollow or recess formed in the case.

The fastener may be of any suitable kind and may for example be a bolt or a screw. Preferably the fastener has a threaded body and a head which is of unique shape or which embodies unique formations so that a dedicated tool is required to actuate the fastener i.e. to engage the fastener with the anchor point or to disengage the fastener from the anchor point.

The anchor point may be on or associated with another battery or may be provided by a member to which a plurality of batteries are, in use, secured. In another form of the invention the anchor point is provided on a casing or rack in which the battery is installed.

In one embodiment the case includes a body of substantially parallelepiped form which has a front end, a rear end, an upper end, a lower end, and two opposed sides, and wherein the lower end includes at least part of the fastener formation.

Preferably at least part of the fastener formation is located on, or is included in, the rear end or, alternatively, the lower end.

The fastener formation may be positioned at one end, or on a side wall, of an elongate passage or channel which extends at the lower end from the front end to the rear end.

The case may include a base above which the energy storage arrangement is located and the passage or channel may be located below the base. The fastener formation is thus accessible only ‘via’ the passage or channel.

It is possible for the battery to include more than one fastener formation.

The provision of the fastener formation below the base at the rear end, or the lower end, of the case means that visibility of, and access to, the fastener formation are restricted. Access to the fastener formation is essentially available only via the passage or channel.

The dedicated tool referred to preferably has an elongate shaft and a socket or other engagement member which carries an actuator of complementary shape to the head of the fastener. Thus the fastener is only actuable by means of the dedicated tool. Additionally, as only restricted visibility of the fastener (when installed) is possible, it is difficult for an unauthorised person to gauge the nature of the fastener and thus be in a position to provide a tool which is capable of actuating the fastener.

The anchor point may be provided on another battery or batteries.

Thus the invention may provide that two or more batteries are coupled together. This may be in place of or in addition to fixing each battery to a separate anchor point e.g. on a rack or cabinet. In a variation of the invention the case includes at least one fastener formation e.g. a hole formed in a tab or flange which may extend from a main body of the case.

### BRIEF DESCRIPTION OF THE DRAWINGS

The invention is further described by way of examples with reference to the accompanying drawings in which :

FIG. 1 illustrates from one side and in elevation a battery according to one form of the invention,

FIG. 2 is an underplan view of the battery shown in FIG. 1,

FIG. 3 shows the battery of FIG. 1 from a front end i.e. in the direction of an arrow marked 3 in FIG. 1,

FIG. 4 is a view in plan of four batteries which are installed in a rack or cabinet,

FIG. 5 is a front view of the installation shown in FIG. 4,

FIG. 6 shows a tool for use with the battery; and

FIG. 7 is a front view of another embodiment wherein four batteries are installed side by side.

### DESCRIPTION OF PREFERRED EMBODIMENTS

FIGS. 1, 2 and 3 are different views of a battery 10 according to one form of the invention. The battery 10 includes a case 12 which contains a lead acid arrangement (not shown), as is known in the art, for electrical energy storage. An understanding of the electrical energy storage arrangement is not necessary for an understanding of the invention. However it is pointed out that the lead contained in the arrangement is a valuable commodity and this makes each battery a possible theft target particularly when the battery is installed at a location, e.g. a cell tower, which is remote and not often policed.

The case 12 which is made from an appropriate plastics material such as ABS or PPO, has a parallelepiped form. The case has a front end 14, a rear end 16, an upper end 18, a lower end 20 and opposed sides 22 and 24 respectively. Electrical terminals 26 and 28 are provided on the upper end 18 close to tine front end 14. The aforementioned features are standard and typical of existing batteries and cases.

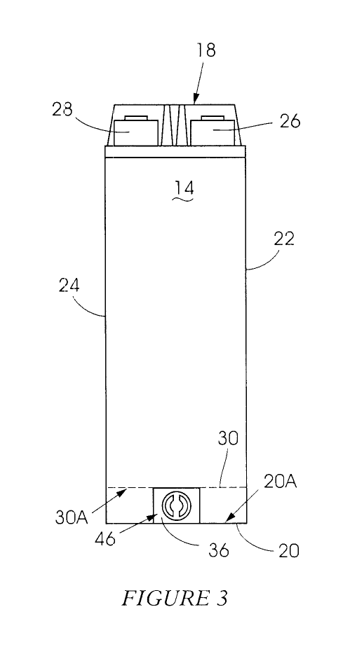

In this example of the invention the case 12 includes a base 30 over and spaced from the lower end 20. The electrical energy storage arrangement is positioned above the base 30 which has a thickness of several millimetres although it is shown only in dotted lines in FIGS. 1 and 3.

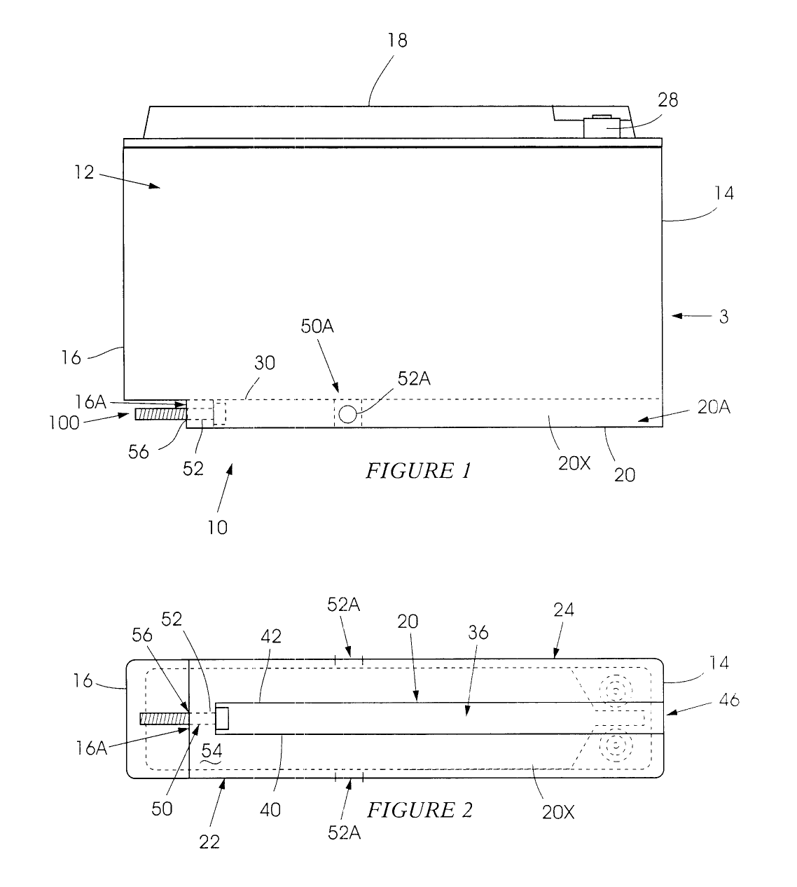

An elongate passage 36 is formed between the base 30 and an upper surface 20A of the lower end 20 which also has a thickness of several millimetres. The passage 36 is preferably centrally positioned between the sides 22 and 24—see FIG. 2 and FIG. 3. The passage 36 has opposed walls 40 and 42 and is bounded on its lower and upper sides by the upper surface 20A, and a lower surface 30A of the base 30. At the front end 14, the passage has a mouth 46. At a junction between the rear end 16 and the lower end 20 the passage 36 terminates in a fixing formation 50 which comprises a hole 52 which extends through a bulky section 54 (of the plastic material of the case) which is integral with the remainder of the case 12. The hole 52 has an outlet 56 at a rear side 16A of the case which is displaced slightly from the rear end 16. Two opposed fixing formations 50A, each comprising a respective hole 52A, can also be formed, near the lower end 20, in the side walls 22 and 24 respectively.

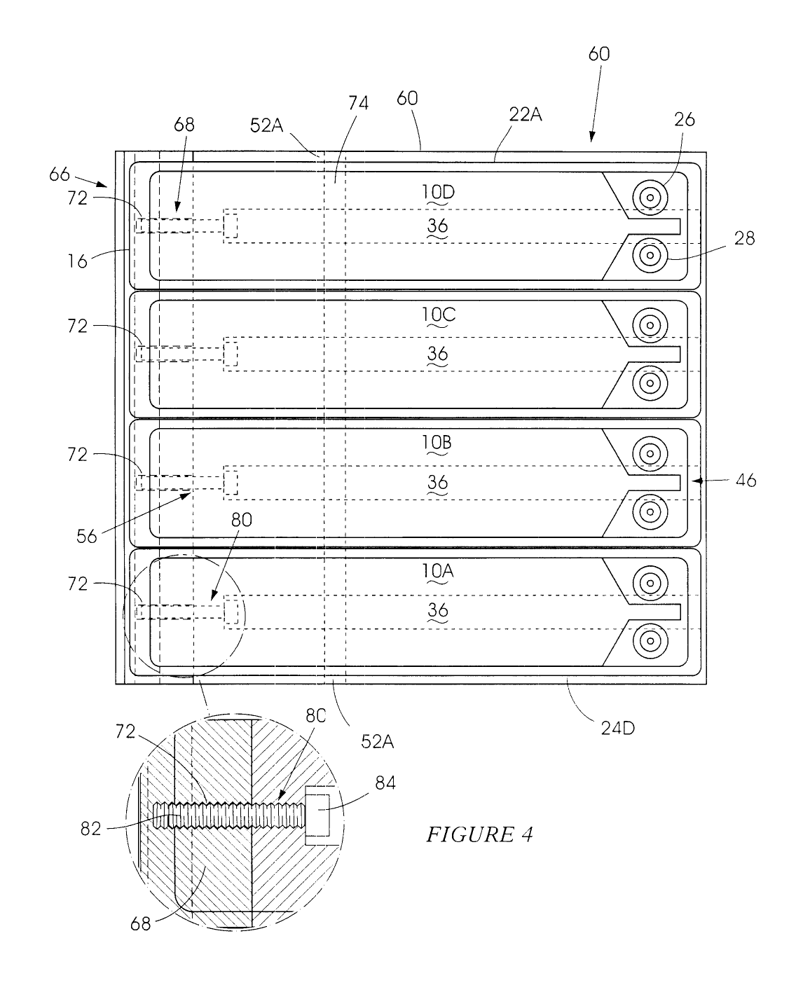

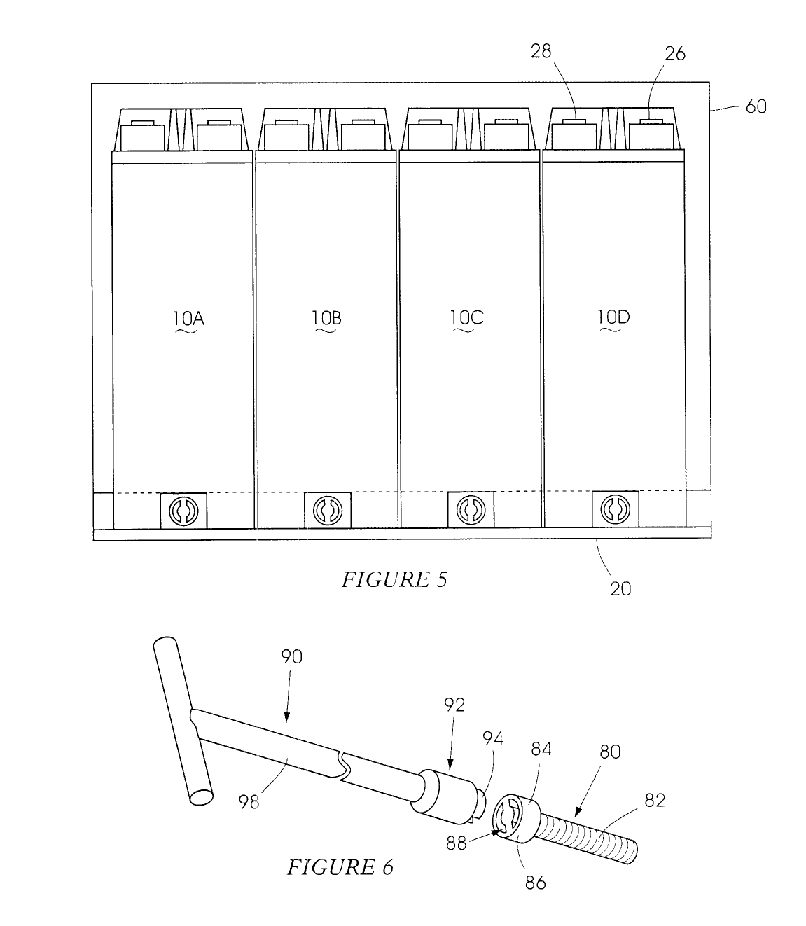

FIG. 4 and FIG. 5 respectively illustrate in plan and from a front side four batteries 10A, 10B, 100 and 10D respectively which are positioned side by side and which are located inside a cabinet or rack 60 which has standard dimensions. The respective terminals 26 and 28 on the upper end of each of the batteries are interconnected in series by means of appropriate conductive links (not shown) as is known in the art to provide an operating voltage of 48 volts.

The cabinet or rack 60 is substantially standardised except that on a rear side 66 against which the respective rear end 16 of the batteries abut, an anchor member 68 is positioned to oppose the outlets 56 from the four batteries 10A to 10D. The anchor member 68 is a stout rod which extends across the rear ends 16 and which has a number of spaced, internally threaded holes 72 and which are positioned so that when the batteries 10A to 10D are correctly installed in the cabinet 60 the various outlets 56 are respectively brought into alignment and in register with the holes 72.

It is pointed out that the function of the anchor member 68 is to tie the four batteries together in a secure manner. It is preferred for added security if the anchor member is in turn fixed to the cabinet 60. This however is not essential.

Each battery 10A to 10D is secured to the cabinet 60 using a respective fastener 80—see FIG. 6. The fastener has a threaded shank 82 which is threadedly engageable with a respective threaded hole 72 and a head 84 which, on an operative face 86, is formed with unique formations 88. The fastener 80 is therefore only actuable by means of a tool 90 which, at a leading end 92, has actuating formations 94 which are complementary in shape to and which are therefore engageable with the formations 88. In this example, which is non-limiting, the formations 88 are shaped recesses or slots, and the formations 94 are correspondingly shaped projections or ribs.

The tool 90 has an elongate shank 98 which has a length greater than the spacing between the rear end 16 and the front end 14 of each battery case 12. The tool can therefore be inserted into the mouth 46 of a passage 36 and can then be advanced along the passage 36 until the leading end 92 reaches the appropriate fixing formation 50. A trailing end of the shank 98 protrudes from the mouth 46 and this enables an operator, not shown, to rotate the tool in one direction or the other in order to advance the respective fastener 80, which is engaged with the leading end 92 of the tool, into threaded engagement with a hole 72 in the anchor member 68 or out of engagement with that hole 72.

In an enhanced form of the invention, a bolt or bar 74, shown in dotted lines in FIG. 4, is used to secure the batteries 10A, 10B, 100 and 10D directly to one another. The bolt 74 extends transversely through the registering holes 52A in the side walls 22 and 24 of each consecutive battery case and optionally is secured using nuts (not shown) at protruding ends at outermost sides 22A and 24D of the four batteries. The batteries are secured together in this way before being collectively pushed into the cabinet 60.

The arrangements described mean that it is difficult for an unauthorised person to remove a single battery 10 from a cabinet 60 in which the battery is installed. The battery is heavy and access to the fastener 80 is limited. The cases 12 of the four batteries fit closely into the cabinet 60 and this prevents the fasteners 80 from being accessed from a side of a battery case 12, or from above or from below the case 12. It is not really possible to flex a battery 10 to and fro inside the cabinet 60 for each battery 10 is adjacent either a side of the cabinet 60 or another battery 10. The fixing formation 50 at the base of each battery is made from a tough plastics material. Thus the possibility of a battery 10 being leveraged out from the cabinet 60 is much reduced.

If a standard cabinet or rack 60 is to be employed without substantial modification, in order to accommodate the battery 10 of the invention, then the anchor member 68 can be constituted by a flat bar of appropriate dimensions welded or otherwise fixed to an interior surface of the cabinet 60. To allow for this the lower end 20 of each battery case 12 can be formed with a recess 100, see FIG. 1, which provides a space within which the anchor member 68 can be positioned when the battery is installed in the cabinet.

It is preferred to fix the case 12 of each battery 10 directly to the cabinet 60. Other arrangements are however possible. For example two batteries can be secured together, generally in the manner described, using an anchor member or plate which is similar to but smaller than, the anchor member 68, and which is provided for the purpose. The plate, in turn, can be secured to an inner surface of the cabinet 60 but this is not essential. The point is that two batteries 10 which are secured to one another, constitute a heavy assembly which is difficult to carry, even by several persons. If the batteries are separated i.e. detached from one another or from the cabinet, without making use of a proper tool, it is more than likely that substantial damage would be caused to the case 12 of each battery and this would reduce the black-market value of the battery 10.

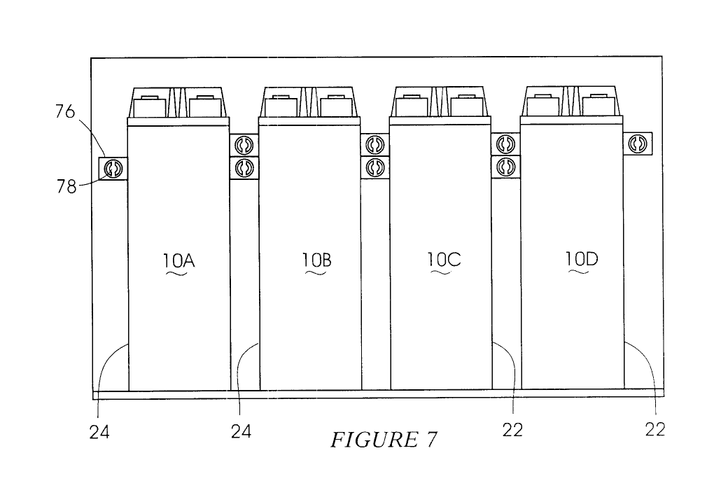

FIG. 7 shows another embodiment wherein four batteries 10A, 10B, 10C and 10D are formed with protrusions 76 on the respective side walls 22 and 24. Each protrusion includes a respective hole 78. The protrusions are staggered in height so that the protrusions on the respective side walls 24 fit under the protrusions on side walls 22. For each protrusion 76 a respective bolt, not shown, is passed through the hole 78 and is secured to a respective wall of a cabinet, or to an anchor member, not shown, with a nut.

The case 12, as noted, is made from an appropriate plastics material using a suitable moulding process. The case can be integrally formed whereby that portion of the case which houses the lead acid arrangement, and that portion of the case 12 (see FIG. 1 for example) which provides the security characteristics of the battery, are integrally formed. This approach can be used with ease in the manufacture of new batteries. However there is a substantial base of installed batteries 10 and a need exists for a capability to upgrade the security ratings of those installed batteries which have conventional cases, i.e. there are no inbuilt security features or formations.

To address the latter aspect it falls within the scope of the invention to form a body, for example from a suitable plastics material which may be the same as the material from which the case 12 is made, which contains security formations similar, for example, to those shown at the bottom of the case 12. For example the base 30, which is shown in a dotted line in FIG. 1, could be a lower end of an existing case and the structure below the base 30 would be formed in a separately moulded body 20X which defines the end 20 and other formations. Consequently, in order to upgrade an existing case 12, the separately moulded body 20X is positioned below the existing case 12 and the body 20X is secured to the case. Different techniques can be used to secure these components together. However it is preferred that a suitable adhesive, designed for the purpose, is employed. This type of adhesive, known in the art, is solvent-based and forms a bond between compatible plastics material which is exceptionally strong. Thereafter the case 12 with the security structure 20X bonded to it is used in the manner which has been described herein.

The bonding technique is not limited to the provision of an equivalent to the case 12 shown in FIG. 1. Separately moulded fastener formations can be bonded or otherwise secured to existing cases 12 to provide formations which are similar to the protrusions 76 shown in FIG. 7. Equivalent fastener formations, separately moulded, can also be provided at other locations on the case.

A benefit of the bonding approach lies in the fact that it is normally not necessary to do modifications to an existing set of tooling used for moulding a battery case. Instead tooling for implementing a security function can be made at a relatively low cost to produce products which are bonded to existing oases as appropriate. The cabinet 60 which is made from sheet metal can be modified or upgraded as required.

1. A battery which includes a case and an electrical energy storage arrangement inside the case, wherein the case includes at least one fastener formation for a fastener which is used to secure the case to an anchor point thereby to restrict unwanted movement of the case.

2. A battery according to claim 1 wherein the case includes a body of substantially parallelepiped form which has a front end, a rear end, an upper end, a lower end, and two opposed sides, and wherein the lower end includes at least part of the fastener formation.

3. A battery according to claim 2 wherein the case includes a base above which the energy storage arrangement is located and an elongate passage below the base which extends from the front end to the rear end and the fastener formation is accessible only via the passage.

4. A battery according to claim 3 wherein the fastener has a threaded body and a head which embodies unique formations so that a dedicated tool is required to actuate the fastener.

5. A battery according to claim 1 wherein the anchor point is on another battery or batteries or is in a cabinet in which the battery is installed.

6. A battery assembly which includes a cabinet, and four side-by-side batteries positioned inside the cabinet, each battery being according to claim 1, and the case of each battery is secured to an anchor point inside the cabinet.
